(19) United States
(12) Patent Application Publication
(10) Pub. No.: US 2016/0353672 A1
(43) Pub. Date: Dec. 8, 2016

(54) Methods and Systems for Growing Plants

(71) Applicant: Shenandoah Growers, Inc., Harrisonburg, VA (US)

(72) Inventor: Robert L. HOFFMAN, Rhoadsville, VA (US)

(21) Appl. No.: 14/733,882

(22) Filed: Jun. 8, 2015

(51) Int. Cl. A01G 7/04; A01G 9/14; A01G 1/00

(52) U.S. Cl. CPC A01G 7/045; A01G 1/001; A01G 9/14

(57) ABSTRACT

The invention relates to methods and systems for growing plants by initiating growth of a plant in a first growing facility and finishing the growth of the plant in a second growing facility. The invention also relates to methods of growing plants by exposing a plant to a light emitting diode after a period of initial growth without LED exposure.

### FIELD OF THE INVENTION

The invention relates to methods and systems for growing plants by initiating growth of a plant in a first growing facility and finishing the growth of the plant in a second growing facility. The invention also relates to methods of growing plants by exposing a plant to a light emitting diode after a period of initial growth without LED exposure.

### BACKGROUND

The standard model of growing a plant for production (e.g., single greenhouse culinary herb and leafy greens production) has thus far been to produce plants at a single growing facility and then cool and ship perishable product as quickly as possible to the customer. The limitations of this method are numerous as time is of the essence in dealing with highly perishable products. Plants are traditionally harvested at a field temperature and subsequently taken to a packing location. There, the product is cooled. This is a slow process and causes a substantial lag time between harvest, packaging, and shipping to a customer. However, if the process is rushed, the herbs stand the risk of forming condensation on the leaves, which increases the chances of cold damage and post-harvest pathogens in the supply chain, both of which, ultimately decrease product shelf-life. With this traditional model, there is also a longer lag time between receipt of customer orders and delivery to customer due to the long distances the plants must be transported after ordering, harvesting, cooling, and packaging. This long lag time reduces the shelf life of the plant upon arrival to the customer. Greenhouse grown potted plants (e.g., herbs) are seeded and or transplanted and grown directly for harvest in a period of 20-60 days, or 30-45 days. At the point of harvest for sale, the products are packaged and then move directly to an area for customer order assembly for boxing and shipping on trucks outbound to the customer wherever that customer may be located. Due to the highly perishable nature of the product, time and distance variances in the supply chain results in disparate product quality and shelf life variance for the end user in retail in order to provide regional and national service. Supply chain uncertainty and planning variables compound the inefficiencies created by a single growing facility. Supply chain productivity additionally requires a large area for any given number of plants being grown, with added cost to the producer.

Herbs are used for culinary purposes, in manufacturing and food industries. A major commercial form of culinary herbs is the dried product, in part because herbs in this form are easy to transport, store and market. A fairly recent development in herb production is fresh herbs, which can be sold in pots or in a harvested bundle. The herbs will provide fresh material to households and, when sold in a pot, an attractive ornamental plant. While fresh herbs are considered more flavorful and superior in quality to dried herbs, widespread commercialization of fresh pot herbs has been restricted due to high perishability and a relatively short shelf life. Methods to increase shelf life, mainly comprise some type of cold storage and/or cold transportation or alternatively by using chemical- or biological agents to improve the general resistance or quality of the herb. Cold storage and/or cold transportation is a method with which to reduce the metabolic activity of a plant, as the rate of biochemical reactions such as respiration in plants is reduced. However, some herbs such as basil and watercress cannot withstand low temperatures as their leaves will darken, discolor, and eventually collapse. Additionally, the aromatic oils can be affected, having a negative impact on the flavor. For these reasons for example basil should not be chilled below 15-10° C., as is common with cold storage and/or cold transport of fresh herbs. Consequently, there are also methods to more specifically address the cold resistance, for example using temperature protective hoods, chemical- or biological agents or by cold hardening the plants during production.

Industrial greenhouse growing of plants includes the steps of sowing and allowing the seed to germinate until it has become a seedling. The duration depends on the plant. The seedling can then generally be put in a nursery area, where the root system is allowed to develop under optimal conditions for this stage of the plant's development, including for example, controlled irrigation. The plant seedling can be allowed to grow in the nursery area for some period of time, which can be 10-14 days, after which the herb can be moved to another area or gully system within the same growing facility. In the gully system the plants can take as much water and fertilizer as needed from below, where a nourishing mix of this is provided.

The plants can be positioned optimally relative each other in the gully system, so that herbs can grow without blocking or being blocked until they are ready for harvest. This phase can take 20-40 days. The total production time can be an average of four to seven weeks until the conventionally grown, fresh plant (e.g., herb pot) is ready to be shipped, however this varies depending on the type of plant, the season, and ambient conditions both inside and outside the growing facility such as a greenhouse. The preferred harvesting time can be in part based on studies of at what maturity stage the flavor or other characteristic of the plant (e.g., herb) is preferable. The preferred harvesting time can also include factors such as the aesthetic aspect of the size of the herb, wherein the preferences can vary with the intended market. Plants such as fresh herbs can have a short shelf life of 6-7 days if delivered undamaged to the store. The short shelf life and the sensibility to cold temperatures show that fresh herbs have a relatively high waste rate. Basil, in particular, has a high waste rate.

There continues to be a need for improved plant production processes and improved plant products.

### BRIEF SUMMARY OF THE INVENTION

The invention is directed to a method of growing a plant, comprising: growing a plant from a seed, seedling, or immature plant in a first growing facility; transporting the plant to a second growing facility; and exposing the plant to a light emitting diode (LED) in the second growing facility. The invention is also directed to a system for growing a plant, comprising: a first growing facility comprising an area configured to initiate growth of a plant or seed; a second growing facility comprising an area configured to allow finishing of the growth of the plant, wherein the finishing comprises exposing the plant to a light emitting diode (LED). The invention is further directed to a method of growing a plant, comprising: exposing a plant to a light emitting diode (LED) after a period of initial growth without LED exposure, wherein the LED exposure comprises a blue light having a wavelength between 440 nm to 495 nm and a red light having a wavelength between 615 nm to 750 nm.

The method or system can further comprise finishing the growth of the plant in the second growing facility. The first growing facility can be a greenhouse, farm, warehouse, or industrial agricultural complex. In some embodiments, the plant is grown for 10 to 60 days in the first growing facility. In some embodiments, the transporting can be by a truck, tray, cart, bin, or conveyor. In some embodiments, the second growing facility is a warehouse, pack house, or distribution center. In some embodiments, the second growing facility comprises an LED growth chamber as a satellite plant finishing room. In some embodiments, the LED emits a wavelength between 440 nm to 495 nm and a wavelength between 615 nm to 750 nm. In some embodiments, the LED exposure comprises 10% to 30% blue light and 70% to 90% red light. In some embodiments, the LED exposure further comprises 1% to 10% green light. In some embodiments, the LED exposure further comprises yellow and orange light. In some embodiments, the LED exposure further comprises 1% to 10% white light.

In some embodiments, the exposing of the plant to the LED is for 12-24 hours followed by a 1-12 hour dark period per day. In some embodiments, the finishing the growth of the plant in the second growing facility is for 1 to 30 days.

In some embodiments, the transportation apparatus transports the plant from the first growing facility to the second growing facility. In some embodiments, the plants from the first growing facility are provided to multiple second growing facilities. In some embodiments, the transportation apparatus is a truck, tray, cart, bin, or conveyor.

In some embodiments, the method or system comprises exposing a plant to a light emitting diode (LED) after a period of initial growth without LED exposure, wherein the LED exposure comprises a blue light having a wavelength between 440 nm to 495 nm and a red light having a wavelength between 615 nm to 750 nm. In some embodiments, the LED exposure comprises 10% to 30% blue light and 70% to 90% red light. In some embodiments, the LED exposure further comprises 1% to 10% green light. In some embodiments, the LED exposure further comprises yellow and orange light. In some embodiments, the LED exposure further comprises 1% to 10% white light.

### BRIEF DESCRIPTION OF THE DRAWINGS/FIGURES

FIG. 1 shows a representative comparison between plants that were produced according to a conventional method (two plants on the left side) and plants that were produced using the invention (two plants on the right side).

### DETAILED DESCRIPTION OF THE INVENTION

As used herein, ranges are inclusive of the end points, and “between” includes the end points of the ranges.

The methods and systems of the invention produce a far superior product, is fully sustainable and operationally efficient. Moreover, these methods and systems change completely the prior model which dictated a need for full, single growing facility regional greenhouses in order to grow, pack and deliver fresh plants (e.g., culinary herbs). Out of first growing facility, in embodiments it will now be possible to produce and deliver regionally grown plants such as culinary herbs over a wide difference with the same freshness and unmatched quality regardless of distance and or location. Advantageously, this agile supply chain methodology can increase overall output, decrease overhead, and increase planning certainty on both the supply and demand sides of the business.

Advantageously, the methods and systems reduce cooling time for the plants and mitigates the decrease in shelf-life as well. Embodiments of these methods and systems result in significantly decreased transportation costs due to the consolidation of loads being shipped to a same geographic region. These methods and systems make it possible to hold plants, in remote locations, without decreasing the quality of the plant. The quality of the plants is significantly increased by these methods and systems, and results in decreased product shrinkage on the production, transport and store levels. Plants grown with these methods or systems in general have been shown to have improved color, stem thickness, height, certain aromatic oil content, chlorophyll content, and certain vitamin or antioxidant content. Qualitatively, these plants exhibit increased flavor. Other improvements observed include thicker and darker green leaves, thicker and stronger stems, increased aromatics, increased cold resistivity, better shelf life, and decreased product shrinkage. These improvements in plant quality indicators, coupled with reduced cooling times and improved shelf life.

The invention is directed to a method of growing a plant, comprising: growing a plant from a seed, seedling, or immature plant in a first growing facility; transporting the plant to a second growing facility; and exposing the plant to a light emitting diode (LED) in the second growing facility. The invention is also directed to a system for growing a plant, comprising: a first growing facility comprising an area configured to initiate growth of a plant or seed; a second growing facility comprising an area configured to allow finishing of the growth of the plant, wherein the finishing comprises exposing the plant to a light emitting diode (LED).

The invention is further directed to a method of growing a plant, comprising: exposing a plant to a light emitting diode (LED) after a period of initial growth (a seed, seedling, or immature plant) without LED exposure, wherein the LED exposure comprises a blue light having a wavelength between 440 nm to 495 nm and a red light having a wavelength between 615 nm to 750 nm. The method or system can further comprise finishing the growth of the plant in the second growing facility.

In some embodiments, the plant is grown for 10 to 60 days in the first growing facility. The transporting can be by a truck, tray, cart, bin, or conveyor. The second growing facility can be a warehouse, pack house, or distribution center. The second growing facility can contain an LED growth chamber as a satellite plant finishing room. In some embodiments, the exposing of the plant to the LED is for 12 hours to 23 hours followed by a dark period of 1 hour to 12 hours per day. The finishing of the growth can be for 1 to 30 days.

The invention can further comprise a transportation apparatus, wherein the transportation apparatus transports the plant from the first growing facility to the second growing facility. The plants from the first growing facility can be provided to multiple second growing facilities. The transportation apparatus can be a truck, tray, cart, bin, or conveyor.

The invention is further directed to a method or system comprising exposing a plant to a light emitting diode (LED) after a period of initial growth without LED exposure, wherein the LED exposure comprises a blue light having a wavelength between 440 nm to 495 nm and a red light having a wavelength between 615 nm to 750 nm. The LED exposure can comprise 10% to 30% blue light and 70% to 90% red light, further comprise 1% to 10% green light, further comprise yellow and orange light, and/or further comprise 1% to 10% white light.

In some embodiments, the first growing facility can be a greenhouse, farm, warehouse, or industrial agricultural complex. The first growing facility can be one of a plurality of first growing facilities. The first growing facility can be generally centrally located with respect to at least one second growing facility. The second growing facility can be referred to as a satellite facility and include satellite plant finishing rooms. The first growing facility can be partially or fully automated. In some embodiments, the first growing facility can include areas configured to initiate growth of a plant. In some embodiments, the first growing facility can include a greenhouse to seed, transplant and grow plants (e.g., potted herbs) to an immature state of growth. In some embodiments, the plant is grown for 10 days to 60 days, 20 days to 40 days, or 25 days to 35 days in the first growing facility. The first growing facility can be configured to increase the throughput of growing the plants, which can increase total output of plants by 10% to 70%.

In some embodiments, the plants (e.g., potted herbs) can be loaded onto trays or multi-layer carts which are moved onto a transportation apparatus. In some embodiments, the transportation apparatus can be a truck, e.g., a refrigerated truck. In embodiments, the transportation apparatus can include a tray, cart, bin, and conveyor. The transportation apparatus can be partially automated in some embodiment. In some embodiments, the transportation apparatus can be fully automated. In some embodiments, the transportation apparatus is configured to depart the first growing facility for a second growing facility, such as an integrated packing and growing warehouse in a regional location or multiple locations. Plants can be removed from the first growing facility (e.g., main production greenhouses) some time prior to the previous harvest date and placed in nursery trays spaced for further grow out or finishing. The finishing can occur on the transportation apparatus or in a second growing facility. Finishing is a stage of growth of the plant such that it is ready for sale, which varies depending on the types of plants and the desired traits.

In some embodiments, the finishing period can be less than one hour, 1 hr to 24 hrs, 5 days, 1 day to 7 days, 1 day to 14 days, or 1 day to 30 days.

Carts can be loaded in some embodiments with filled nursery trays and each cart can be loaded onto a refrigerated truck for transportation to the second growing facility. In embodiments, the need to remove field heat from plants is reduced because the plants might not be sleeved prior to transporting from the first growing facility to the second growing facility and thus are less susceptible to the formation of condensation on the foliage. In some embodiments, temperature differentials can be controlled such that the plants are transported matching closely the first growing facility temperature. Plants can be grown, e.g., in 8 cm square pots and be harvested from the first growing facility. In some embodiments, the growth trays can be the same as the transportation trays. In some embodiments, the growth of the plant is initiated in the transportation apparatus. The trays can be placed onto the shelves of a transportation apparatus. The carts can be stored in a temperature and humidity controlled environment prior to loading onto the transportation apparatus such as a climate controlled truck to be transported to a second growing facility such as a pack house or distribution center.

The second growing facility can be one of a plurality of second growing facilities. Upon arrival at the second growing facility, in some embodiments the plants can be finished. In some embodiments, the second growing facility can include at least one of a pack house, distribution center, and growing facility. The plants can be placed onto flood and ebb benches at the second growing facility in some embodiments. For example, the 8 cm pots can be arranged in a plant density of 4-8 plants, 5-7 plants, or 5.7 plants per square foot or 50 to 70, 55 to 65, or 62 plants per square meter on the flood/ebb benches.

The second growing facility can include LED growth chambers. In some embodiments, the second growing facility can be an integrated regional warehouse, and can include LED growth chambers as satellite plant finishing rooms for plants. The second growing facility can be a fully enclosed and temperature controlled grow chamber where the plants can be placed on flood and ebb benches under a calibrated and timed LED, or LED lighting array. The LED or LED lighting array can be built to deliver 100% usable light in the different wavelengths to continue to grow the plants either with or without natural sunlight for 1 and 30 days, depending on the type of plant. The plants in some embodiments can be housed in the second growing facility for 1 to 30 days. They plants can be irrigated with nutrients and fertilizer (including organic nutrients) in an enclosed pump and return system in some embodiments.

During the time in the second growing facility (e.g., LED growth/finishing chamber), the plants can increase qualitative and quantitative characteristics, and for example can become much stronger, darker and more aromatic than is possible in any single growing facility or single greenhouse process. The resulting product can exhibit much higher aromatic oil content and can be superior in habit to even the most ideal naturally grown outdoor plants. Cold-chain resistance and shelf life can also be considerably improved in some embodiments. Plants can be exposed to LED light for 1 day to 30 days. In some embodiments, the LED light can be applied to the plant for 12 hours to 23 hours, 15 hours to 20 hours, or 18 hours, followed by a dark period of 1 hours to 12 hours, 4 hours to 9 hours, or 6 hours, where the LED light is not applied to the plant. These on/off cycles can be varied according to the type of plant, season, status of the first growing facility, status of the second growing facility, production supply, or customer demand, for example. In some embodiments, the plant can be exposed to LED light for 18 hours, followed by a 6 hour dark period. LED lights can be mounted above the leaf canopy, such that uniform light distribution is achieved.

Light intensity of 50-900 micromoles per cm² per sec, 200 to 260 micromoles per cm² per sec, or 190-200 micromoles per cm² per sec can be applied. In some embodiments, LED light can include blue light of 440 nm to 495 nm and red light of 615 nm to 750 nm. In some embodiments, LED light can include blue light of 450 nm to 495 nm and red light of 620 nm to 750 nm. In some embodiments, LED light can include blue light of 450 nm and red light of 625 nm and 660 nm. In some embodiments, the LED light can include green light of 495 nm to 570 nm, e.g., 530 nm. The LED light can further include yellow and orange light, and/or white light. The LED light can be 10% to 30% blue light and 70% to 90% red light. The LED light can be 10% to 20% blue light and 80% to 90% red light. For example, the LED light can be 14% blue light and 79% red light. In some embodiments, the LED light can be 14% blue with a wavelength of 450 nm Royal Blue, 7% Green/White with a wavelength of 530 nm Green, and 79% red light with a wavelengths of 625 nm Red and 660 nm Deep Red. In some embodiments, 1-10% of light in the green, yellow, orange wavelengths can be applied. An LED light can be configured to emit a wavelength of 380 to 750 nm. The LED can include red (620-670 nm) and blue (450-490 nm) wavelengths. In some embodiments, a portion of green and more blue towards white wavelengths can be applied.

When the LED light not applied in the second growing facility, the temperature in the second growing facility can be 60° F. to 65° F. When the LED is applied, the temperature in the second growing facility can increase to 70° F. to 80° F., for example to 74° F. Temperature of the second growing facility can be controlled to be 50-90° F., 60-80° F., 60-75° F., 60-65° F., or 65-75° F.

Relative humidity can be controlled to 30-90%, 40-80%, or 50-70%.

In some embodiments, a single variety of plant can be assigned to one second growing facility and a separate variety of plant can be assigned to a separate second growing facility. In other embodiments, multiple varieties of plants can be finished at the same second growing facility, and thus experience the same finishing conditions.

Other conditions within the second growing facility can be controlled to promote plant finishing. For example, in some embodiments, carbon dioxide can be maintained to a minimum level of 100 ppm to 350 ppm. Plants can be irrigated when the moisture content of the growing media drops below a certain percentage, for example 50%. In some embodiments, the fertilizer solution can be based on the time of the year, growth-rate, deficiencies, etc.

The plants in the invention can be, e.g., herbs, food plants, or flowers. Herbs can include culinary herbs, e.g., basils (Genovese, purple, lemon, and Thai), cilantro, parsley, dill, oregano, thyme, sage, mint, rosemary, and chives. Food plants can include leafy greens, e.g., lettuce, cabbage, watercress, wheat grass, catnip, kale, mustard greens, dandelion, chard, and beet greens. The plants can be therapeutic plants, e.g., marijuana, Echinacea, ginseng, mint, and other medicinal plants.

As daily orders arrive at each regional facility in some embodiments, the plants can be taken from the second growing location area where LED light is applied (e.g., growing chamber(s)) and can enter a packaging, boxing and assembly operation. In some embodiments, the boxed final product is loaded on a second transportation apparatus (e.g., outbound truck) that can be dedicated or include other product lines to customers. These methods and systems can produce a far superior product and can be fully sustainable and operationally exceeding efficient. These methods are an improvement over the prior model which dictated a need for full regional greenhouses in order to grow, pack and deliver fresh culinary herbs. For example, out of a single hub greenhouse first growing location in Harrisonburg Virginia, it will now be possible to produce and deliver regional grown culinary herbs from New England to Florida to Texas to Chicago and all points in between with exactly the same freshness and unmatched quality regardless of distance and or location. This is both a first for the herb industry and also groundbreaking for the greenhouse growing industry as it represents a completely new process and resulting dramatically improved product quality.

In some embodiments, there is a positive difference of 1-10%, 10-50%, 50-100% between the stem height of a non-treated plant and the taller treated plant that is allowed to finish growing in a second growing facility while exposed to the finishing conditions. In some embodiments, there is a positive difference of 1-10%, 10-50%, or 50-100% between the stem width of a non-treated plant and the taller treated plant that is allowed to finish growing in a second growing facility while exposed to the finishing conditions.

In some embodiments, plants grown using the methods or systems can display an increase in chlorophyll of 5-110%, 5-45%, or 10-35% in a treated plant that is allowed to finish growing in a second growing facility compared to a non-treated plant.

In some embodiments, Vitamin E can increase from 5-100%, 5-90%, or 5-50% in a treated plant that is allowed to finish growing in a second growing facility compared to a non-treated plant. Beta-Carotene, Lutein, and Vitamin C increased similar amounts. Other valued contents such as Zeaxanthin (mcg/serving), Polyphenols (g/serving), or Volatile Oils (mg/serving) can increase 5-100%, 5-90%, or 5-50% in a treated plant that is allowed to finish growing in a second growing facility compared to a non-treated plant.

### EXAMPLES

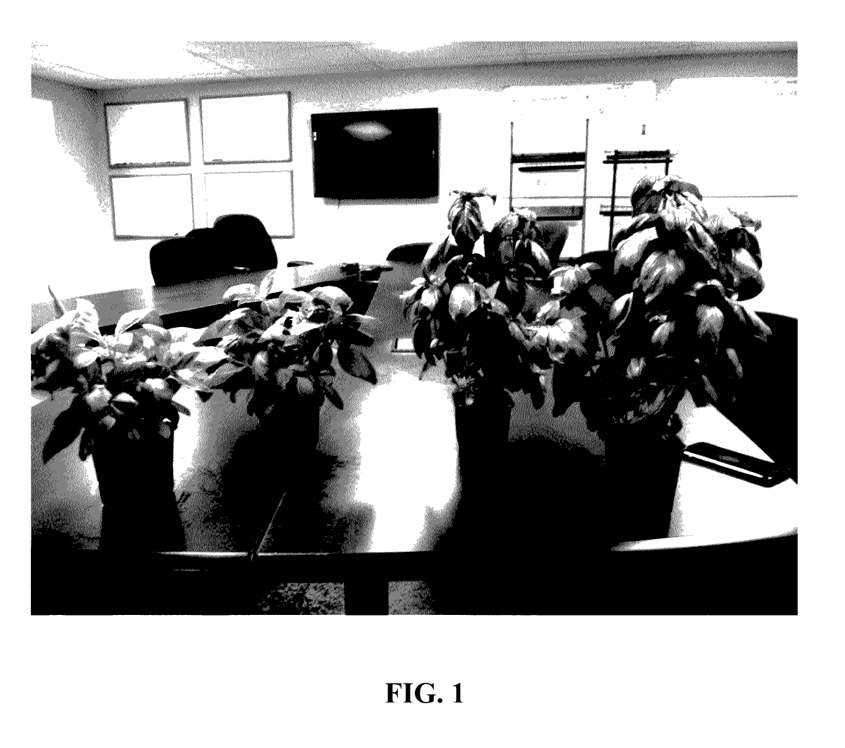

FIG. 1 shows a representative comparison between two basil plants on the left that have not been finished with the claimed methods or systems and two basil plants on the right that have been finished with the claimed methods or systems. The plants produced with these methods or systems exhibit a stronger, darker green color. As shown in the FIGURE, stem thickness, height, leaf shape and surface area, are shown to have dramatically increased. Qualitatively, these plants exhibit increased flavor. Other improvements observed include thicker and darker green leaves, thicker and stronger stems, increased aromatics, increased cold resistivity, better shelf life, and decreased product shrinkage.

Stem height and thickness/width tests were conducted over three trials, with three treated plants and three untreated plants used in each trial. The test results addressed the comparison of three plants harvested from the greenhouse as normal (without treatment) and three plants harvested from the greenhouse 5 days early and spending the remaining five day in a second growing location including the LED chamber (with treatment). The resulting stem heights and widths are measured. Plant height is measured by assigning numbers to test plants and measuring the tallest point in the foliage from the level of the rim of the pot both before and after the finishing stage. Measurements were taken in millimeters and then averaged by adding all data points per pot and dividing by the number of plants in the corresponding section. These data are compared to measurements taken of plants of the same age held at room temperature with no LED treatment. Results are described in Table 1 below:

TABLE 1
Stem Thickness and Height Examples

| | | |
|---|---|---|
| | Average % Difference | Max % Difference |
| | between Treated and | between Treated |
| Variety | Untreated | and Untreated |

| | | | | |
|---|---|---|---|---|
| Genovese | Height | 13.87 | Height | 34.15 |
| Basil | Width | 16.59 | Width | 59.52 |
| Cilantro | Height | 4.06 | Height | 27.27 |
| | Width | 15.43 | Width | 88.89 |
| Parsley | Height | 27.52 | Height | 65.22 |
| | Width | 13.84 | Width | 70.45 |
| Dill | Height | 16.04 | Height | 46.67 |
| | Width | 10.59 | Width | 30.24 |
| Oregano | Height | 9.58 | Height | 76.47 |
| | Width | 11.94 | Width | 86.44 |
| Thyme | Height | 21.35 | Height | 2585.14 |
| | Width | 7.61 | Width | 36.84 |
| Sage | Height | 4.79 | Height | 38.89 |
| | Width | 25.21 | Width | 66.49 |
| Mint | Height | 5.86 | Height | 28.70 |
| | Width | 10.85 | Width | 36.65 |
| Rosemary | Height | 1.07 | Height | 21.43 |
| | Width | 9.02 | Width | 34.83 |
| Chives | Height | 6.76 | Height | 28.00 |
| | Width | 0.60 | Width | 38.21 |

Plant Color and/or Chlorophyll Content was assessed using digital photography in a location with controlled lighting and background as well as a handheld chlorophyll test device known as the atLEAF. Test plants were assigned numbers and photographs are taken of each plant prior to entering into the second growing facility (e.g., LED chamber). The 6 varieties used in this trial were selected because the leaf size is conducive to use of the atLEAF+ (made by FT GREEN LLC, of Wilmington, Del.) handheld device. This device noninvasively measures the relative chlorophyll content of the plant. Plant relative chlorophyll concentration is measured by inserting a leaf into the device aperture and using optical density difference at two wavelengths (660 nm and 940 nm).

The chlorophyll test procedure used was as follows:
1. Collect 6 plants of each of 6 varieties (basil, cilantro, parsley, sage, mint, oregano)
2. Move sample plants to a cart outside second growing facility
3. Tag one leaf on each plant using an Avery 12204 white tag
4. Slide the leaf tip of the tagged leaf into the slot on the atLEAF+ meter and take 5 measurements, moving the meter slightly as measuring to account for the contours of the leaf
5. Place the plants in the second growing facility LED chamber for the described 5 day treatment time
6. Remove plants from the second growing facility LED chamber and place them on a cart outside of the second growing facility LED chamber
7. Repeat measurements post-treatment using the procedure described in step 4

Certain Antioxidant and Vitamin levels were tested for including types of antioxidants that are believed to have positive effects on human health. These antioxidants included; Vitamin C, Vitamin E, Carotenoids, and Phenols. Samples of plant tissue from each herb/green were analyzed in a laboratory before and after the five day duration in the second growing facility. Aromatic oil content was measured by laboratory testing. Samples of plant tissue from each herb/green were analyzed in a laboratory before and after the five day duration in the second growing facility. Other antioxidants, vitamins, and compositions tested for included Vitamin E, b-Carotene, Lutein, Zeaxanthin, Vitamin C, Polyphenols) and the Volatile Oils (e.g., aromatic oils and essential oils).

To test for Vitamin C, the tester used an HPLC/UV/C 18 column system, methanol, ascorbic acid (Sigma), 0.05 M acetate buffer pH 3.8-4.0, ascorbic acid standard solution: 10-200 ppm. AOAC and USP reference were used. The samples were prepared directly in buffer at concentration of 1-10 mg/mL. This sample was then diluted with buffer to appropriate concentration for HPLC analysis. The sample was ground and composed. A portion of the sample was weighed and extracted with acetate buffer as above. Samples were then filtered through a membrane prior to HPLC analysis. Samples of 20 microliters were injected into HPLC equipped with C18 column at 25 C, UV detector at 280 nm under isocratic condition of 2-3% methanol in water. Data were then collected and analyzed using a chromatography workstation based on external standard calibration method.

To test for Vitamin E and Tocopherols, the tester utilized a method developed based on USP and AOAC methods with modifications using GC-FID with Capillary column. The tester used a GC system equipped with FID, DB-5 Column or equivalent, Injector, Ethanol, 50% KOH, Hexane or Chloroform, Standards of all forms of Tocopherols from Sigma. According to the method used, Alpha-Cholestane from Sigma may be used as IS. Standards and concentrated vitamin E samples were prepared directly in hexane, samples containing oils were saponified and then extracted into ethyl ether and exchanged to hexane in final preparation. Other samples can be prepared as oil-based samples or suspended in DMSO and then extracted into hexane. In both cases, antioxidant of ascorbic acid and BHT are included. IS is added at concentration of 200 ppm in the final preparation for the internal standard calibration method. 1 or 2 microliters of the final extract were injected into a GC equipped with DB-5 capillary column and FID. A temperature gradient was run for separation and elution. Data were collected and analyzed by a data workstation using external standard calibration method. An internal standard calibration method using alpha-Cholestane could also be used. For tocopherol succinate, two tests are performed: (1) do a direct extraction for identity of tocopherol succinate; (2) if the recovery is not good, perform a saponification and analyze tocopherol then back calculated as succinate form.

To test for Carotenenoids, including Lycopene, Lutein, Zeaxanthin and other carotenoids, the tester used as reference AOAC 16th and Anal. Chem. News & Features, 299A (1996). An HPLC/UV-VIS/C18 column system was used, along with methanol, ethanol, butylated hydroxytoulene (BHT), with standard solutions in ethanol. The samples were prepared in a strong fat-soluble solvent and then diluted into ethanol containing BHT. The concentration is determined by spectrophotometer for Beta-Carotene, Lutein, Lycopene, and their concentrations were calculated using their extinction coefficients prior to diluting with ethanol containing BHT as calibration standards. The samples were prepared as follows: Beta-Carotene, Lycopene or Lutein sample with high concentration were prepared directly in a fat-soluble solvent then diluted in ethanol containing BHT. A Micro-capsulated sample was dissolved in a DMSO:Water mixture then followed by an extraction with methylene chloride. The samples were diluted with ethanol. Samples were dissolved in DMSO then followed by an extraction with methylene chloride. The samples were diluted with ethanol. If esters of Lutein, Zeaxanthin and astaxanthin were present, a saponification procedure was used followed by extraction with methylene chloride. If carotenes were the only desired compounds, stronger saponification procedures could be used. Some samples could require a mixture of hexane:acetone:toluene:alcohol as described in AOAC. The samples were injected into an HPLC system and analyzed via an isocratic run with methanol or a gradient run with both acetone and water. Data were collected and analyzed using a chromatography workstation based on external standard calibration method. Because Lycopene is particularly unstable, internal standard calibration method could also be used. To test for volatile oils, FCC 9 page 1424 was used.

Exemplary test results are shown below in Table 2:

TABLE 2

| | Un-Treated | Treated | % Inc/Dec |
|---|---|---|---|
| | Cilantro | | |
| Vitamin E (IU/serving) | 35.52 | 28.8 | −18.918919 |
| b-Carotene (mg/serving) | 40.71 | 47.17 | 15.868337 |
| Lutein (mg/serving) | 74.997 | 79.779 | 6.37625505 |
| Vitamin C (mg/serving) | — | — | |
| | Dill | | |
| Vitamin E (IU/serving) | 20.22 | 32.58 | 61.1275964 |
| b-Carotene (mg/serving) | 49.32 | 65.89 | 33.5969181 |
| Lutein (mcg/serving) | 91.648 | 111.379 | 21.5291114 |
| Vitamin C (mg/serving) | 1480 | 1677 | 13.3108108 |
| | Oregano | | |
| Vitamin E (IU/serving) | 15.49 | 17.14 | 10.6520336 |
| b-Carotene (mg/serving) | 28.61 | 49.76 | 73.925201 |
| Lutein (mg/serving) | 54.062 | 81.514 | 50.7787355 |
| Vitamin C (mg/serving) | 1.17 | 1.65 | 41.025641 |
| | Rosemary | | |
| Vitamin E (IU/serving) | 41.84 | 34.96 | −16.443595 |
| b-Carotene (mg/serving) | 13.49 | 17 | 26.0192735 |
| Lutein (mg/serving) | 25.018 | 27.525 | 10.020785 |
| Vitamin C (mg/serving) | 4.02 | 3.82 | −4.9751244 |
| | Chives | | |
| Vitamin E (IU/serving) | 33.7 | 28.71 | −14.807122 |
| b-Carotene (mg/serving) | 34.55 | 32.83 | −4.9782923 |
| Lutein (mg/serving) | 53.967 | 57.696 | 6.9097782 |
| Vitamin C (mg/serving) | 734 | 912 | 24.2506812 |
| | Basil | | |
| Vitamin E (IU/serving) | 45.53 | 26.8 | −41.137711 |
| b-Carotene (mg/serving) | 52.04 | 55.92 | 7.45580323 |
| Lutein (mg/serving) | 84.43 | 91.686 | 8.59410162 |
| Vitamin C (mg/serving) | 6.86 | 7.36 | 7.28862974 |
| | Parsley | | |
| Vitamin E (IU/serving) | 19.37 | 20.39 | 5.26587506 |
| b-Carotene (mg/serving) | 36.99 | 43.44 | 17.4371452 |
| Lutein (mg/serving) | 57.308 | 64.046 | 11.7575208 |
| Vitamin C (mg/serving) | 196 | 183 | −6.6326531 |
| | Thyme | | |
| Vitamin E (IU/serving) | 15.12 | 18.82 | 24.4708995 |
| b-Carotene (mg/serving) | 35.1 | 35.12 | 0.05698006 |
| Lutein (mg/serving) | 57.224 | 60.858 | 6.35048232 |
| Vitamin C (mg/serving) | 7.72 | 9.43 | 22.1502591 |
| | Sage | | |
| Vitamin E (IU/serving) | 21.07 | 25.66 | 21.7845278 |
| b-Carotene (mg/serving) | 33.57 | 39.72 | 18.3199285 |
| Lutein (mg/serving) | 52.163 | 65.543 | 25.6503652 |
| Vitamin C (mg/serving) | 16.71 | 17.43 | 4.30879713 |
| | Mint | | |
| Vitamin E (IU/serving) | 18.66 | 35.66 | 91.1039657 |
| b-Carotene (mg/serving) | 50.4 | 39.31 | −22.003968 |
| Lutein (mg/serving) | 74.747 | 61.317 | −17.967276 |
| Vitamin C (mg/serving) | 1.64 | 3.9 | 137.804878 |

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method of growing a plant, comprising:
growing a plant from a seed, seedling, or immature plant in a first growing facility;
transporting the plant to a second growing facility; and
exposing the plant to a light emitting diode (LED) in the second growing facility.

2. The method of claim 1, further comprising finishing the growth of the plant in the second growing facility.

3. The method of any one of claims 1-2, wherein the first growing facility is a greenhouse, farm, warehouse, or industrial agricultural complex.

4. The method of any one of claims 1-3, wherein the plant is grown for 10 day to 60 days in the first growing facility.

5. The method of any one of claims 1-4, wherein the transporting can be by a truck, tray, cart, bin, or conveyor.

6. The method of any one of claims 1-5, wherein the second growing facility is a warehouse, pack house, or distribution center.

7. The method of any one of claims 1-6, wherein the second growing facility comprises an LED growth chamber.

8. The method of any of claims 1-7, further comprising finishing the growth of the plant in the second growing facility for 1 day to 30 days.

9. The method of any one of claims 1-9, wherein the LED emits a wavelength between 440 nm to 495 nm and a wavelength between 615 nm to 750 nm.

10. The method of any one of claims 7-8, wherein the exposing of the plant to the LED is for 12 hours to 23 hours followed by a dark period of 1 hour to 12 hours per day.

11. The method of any one of claims 1-10, wherein the LED exposure comprises 10% to 30% blue light and 70% to 90% red light.

12. The method of claim 11, wherein the LED exposure further comprises 1% to 10% green light.

13. The method of any one of claims 11-12, wherein the LED exposure further comprises yellow and orange light.

14. The method of any one of claims 11-13, wherein the LED exposure further comprises 1% to 10% white light.

15. A system for growing a plant, comprising:
a first growing facility comprising an area configured to initiate growth of a plant or seed;
a second growing facility comprising an area configured to allow finishing of the growth of the plant,
wherein the finishing comprises exposing the plant to a light emitting diode (LED).

16. The system of claim 15, further comprising:
a transportation apparatus,
wherein the transportation apparatus transports the plant from the first growing facility to the second growing facility.

17. The system of any one of claims 15-16, wherein the plants from the first growing facility are provided to multiple second growing facilities.

18. The system of any one of claims 15-17, wherein the first growing facility is a greenhouse, farm, warehouse, or industrial agricultural complex.

19. The system of claim 16, wherein the transportation apparatus is a truck, tray, cart, bin, or conveyor.

20. The system of any one of claims 15-19, wherein the second growing facility is a warehouse, pack house, or distribution center.

21. The system of any one of claims 15-20, wherein the second growing facility comprises an LED growth chamber.

22. The system of any one of claims 15-21, wherein the LED emits a wavelength between 440 nm to 495 nm and a wavelength between 615 nm to 750 nm.

23. The system of any one of claims 15-22, wherein the LED exposure comprises 10% to 30% blue light and 70% to 90% red light.

24. The system of claim 23, wherein the LED exposure further comprises 1% to 10% green light.

25. The system of any one of claims 23-24, wherein the LED exposure further comprises yellow and orange light.

26. The system of any one of claims 23-25, wherein the LED exposure further comprises 1% to 10% white light.

27. A method of growing a plant, comprising:
exposing a plant to a light emitting diode (LED) after a period of initial growth without LED exposure,
wherein the LED exposure comprises a blue light having a wavelength between 440 nm to 495 nm and a red light having a wavelength between 615 nm to 750 nm.

28. The method of claim 27, wherein the LED exposure comprises 10% to 30% blue light and 70% to 90% red light.

29. The method of any one of claims 27-28, wherein the LED exposure further comprises 1% to 10% green light.

30. The method of any one of claims 27-29, wherein the LED exposure further comprises yellow and orange light.

31. The method of any one of claims 27-30, wherein the LED exposure further comprises 1% to 10% white light.
